(19) United States
(12) Patent Application Publication
(10) Pub. No.: US 2019/0085914 A1
(43) Pub. Date: Mar. 21, 2019

(54) BI-DIRECTIONSL WEDGE CLUTCH COLLAPSING INNER RACE

(71) Applicant: Schaeffler Technologies AG & Co. KG, Herzogenaurach (DE)

(72) Inventor: Joshua Hixenbaugh, Wooster, OH (US)

(73) Assignee: Schaeffler Technologies AG & Co. KG, Herzogenaurach (DE)

(21) Appl. No.: 16/080,076

(22) PCT Filed: Mar. 1, 2016
(86) PCT No.: PCT/US16/20264

§ 371 Date: Aug. 27, 2018

(51) Int. Cl. F16D 41/08; F16D 41/063

(52) U.S. Cl. CPC F16D 41/082; F16D 41/063

(57) ABSTRACT

A bi-directional wedge clutch for a motor vehicle drive train is provided. The bi-directional wedge clutch includes a driver; an inner race configured for being driven by the driver; a wedge plate on an outer circumferential surface of the inner race and an outer race on an outer circumferential surface of the wedge plate. The inner race and the wedge plate are configured such that torque is transferrable in two rotational directions from the inner race to the outer race via the wedge plate. The clutch also includes a releaser configured for sliding axial in a channel formed in the outer circumferential surface of the inner race and engaging the wedge plate to release the clutch when the inner race is rotating in either of the two rotational directions. A method of forming a bi-directional wedge clutch for a motor vehicle drive train is also provided.

The present disclosure relates generally to motor vehicle clutches and more specifically to bi-directional wedge clutches.

### BACKGROUND

Conventional bi-directional wedge clutches do not release unless zero torque is achieved. A bi-directional wedge clutch disclosed in U.S. application Ser. No. 14/872,617, which is commonly owned by the assignee of the present application, may possibly work under very low torque applications, but wedge plates of the inner race may be bound against each other too hard to release under high torque applications.

U.S. Pub. No. 2014/0332335 A1 and U.S. Pub. No. 2014/0291099 also disclose bi-directional wedge clutches.

### SUMMARY OF THE INVENTION

A bi-directional wedge clutch for a motor vehicle drive train is provided. The bi-directional wedge clutch includes a driver; an inner race configured for being driven by the driver; a wedge plate on an outer circumferential surface of the inner race and an outer race on an outer circumferential surface of the wedge plate. The inner race and the wedge plate are configured such that torque is transferrable in two rotational directions from the inner race to the outer race via the wedge plate. The clutch also includes a releaser configured for sliding axial in a channel formed in the outer circumferential surface of the inner race and engaging the wedge plate to release the clutch when the inner race is rotating in either of the two rotational directions.

A method of forming a bi-directional wedge clutch for a motor vehicle drive train is also provided. The method includes providing an inner race onto an outer circumferential surface of a driver; providing a wedge plate on an outer circumferential surface of the inner race; providing an outer race on an outer circumferential surface of the wedge plate such that the inner race and the wedge plate are configured such to transfer torque in two rotational directions from the inner race to the outer race via the wedge plate; and providing a releaser configured for sliding axial in a channel formed in the outer circumferential surface of the inner race and engaging the wedge plate to release the clutch when the inner race is rotating in either of the two rotational directions.

### BRIEF DESCRIPTION OF THE DRAWINGS

The present invention is described below by reference to the following drawings, in which:

FIG. 1a shows a cross-sectional side view of a bi-directional wedge clutch for a motor vehicle drive train in accordance with an embodiment of the present invention in a locked orientation of the clutch;

FIG. 1b shows a cross-sectional side view of a bi-directional wedge clutch for a motor vehicle drive train in accordance with an embodiment of the present invention in a released orientation of the clutch;

FIG. 2 shows a perspective view of the bi-directional wedge clutch shown in FIGS. 1a, 1b; and

FIG. 3 shows an exploded view of the bi-directional wedge clutch shown in FIGS. 1a, 1b and 2.

### DETAILED DESCRIPTION

The disclosure provides a bi-directional wedge clutch configured to release under torque. The wedge clutch includes a conned driver, a collapsing inner race, an outer race, a wedge plate, wedge blocks, end caps, and a wedge block plate. In the locked state, torque is transmitted to the end cap(s) and into the inner race via a mechanical connection. The wedge plate then ramps to the outer profile of the inner race and outward to the outer race, transmitting torque to the outer race. In the release state, the wedge block plate is actuated toward the block plate, causing the blocks to contact the wedge plates, forcing the conned driver to the inner race and preventing the blocks from following the outer profile of the inner race.

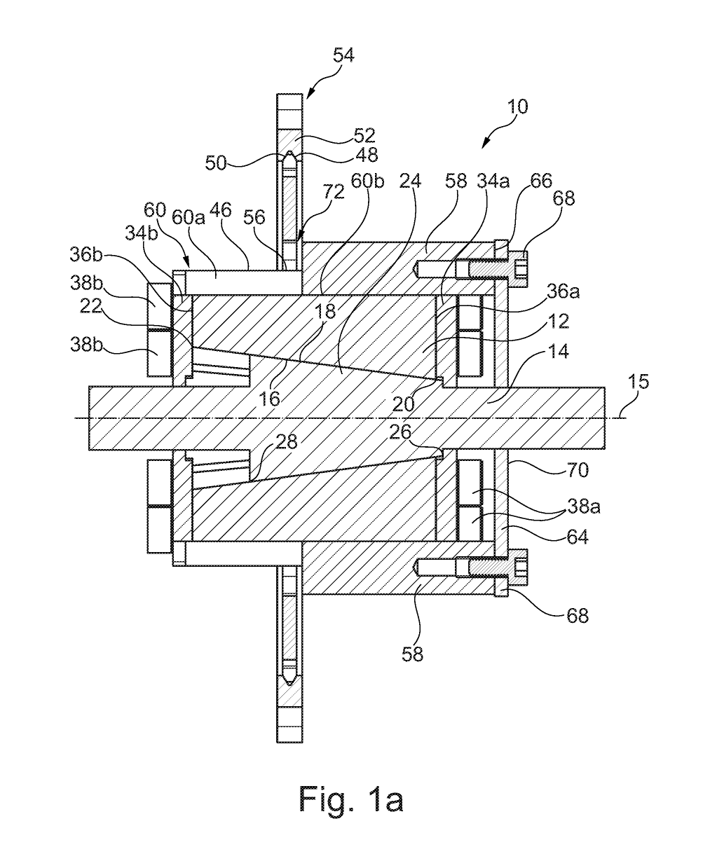

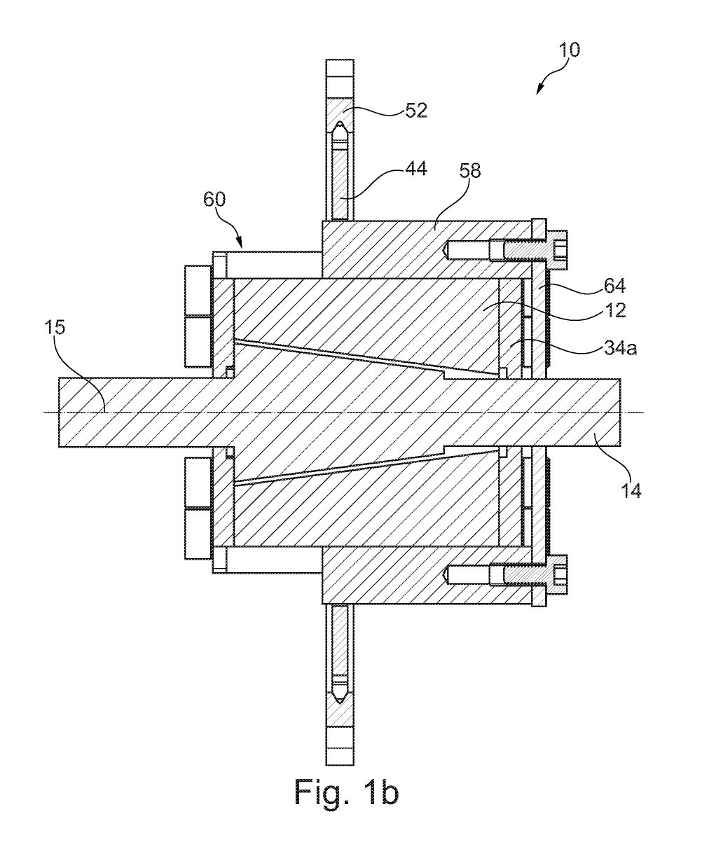

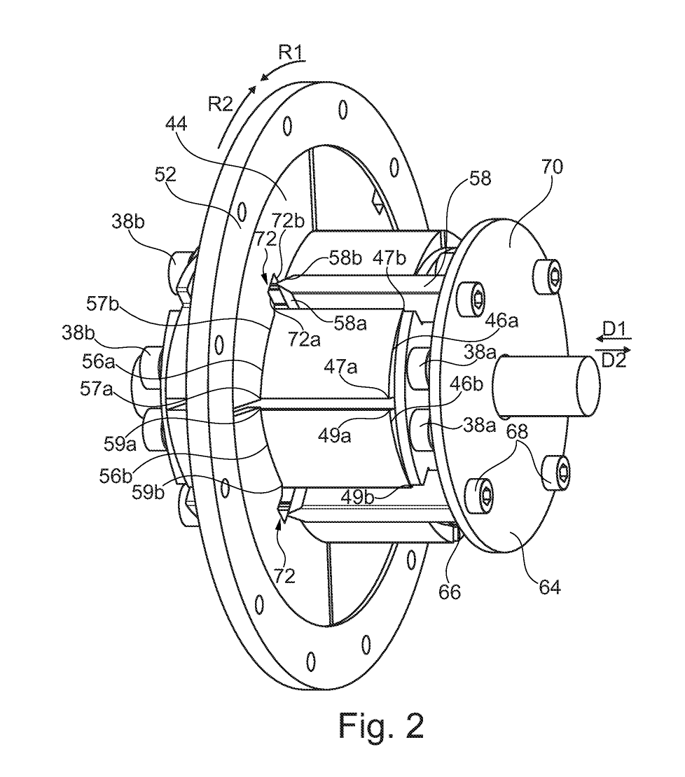

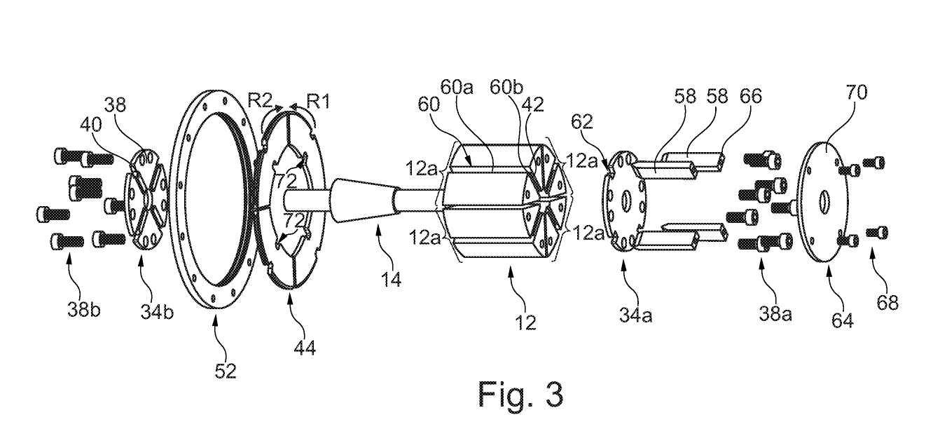

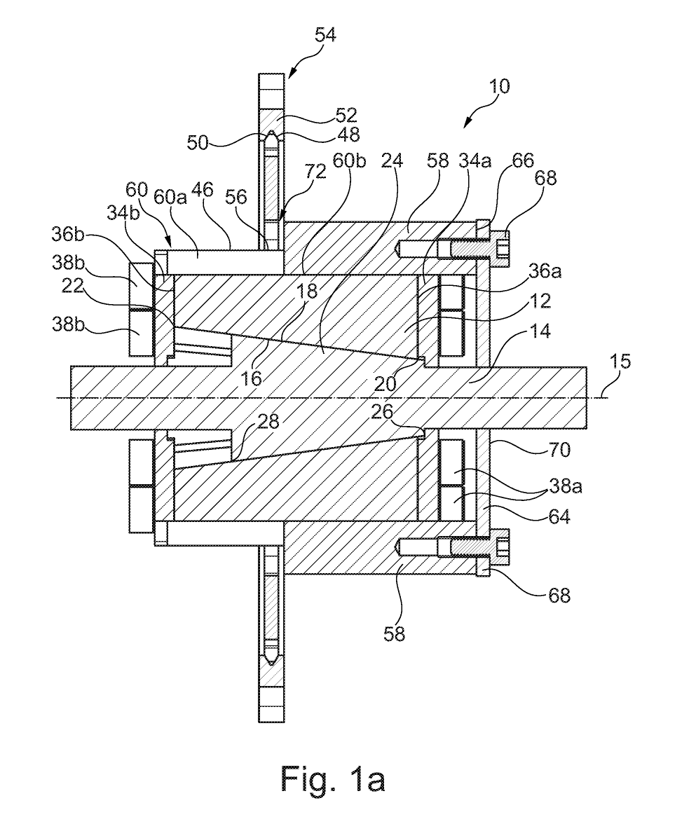

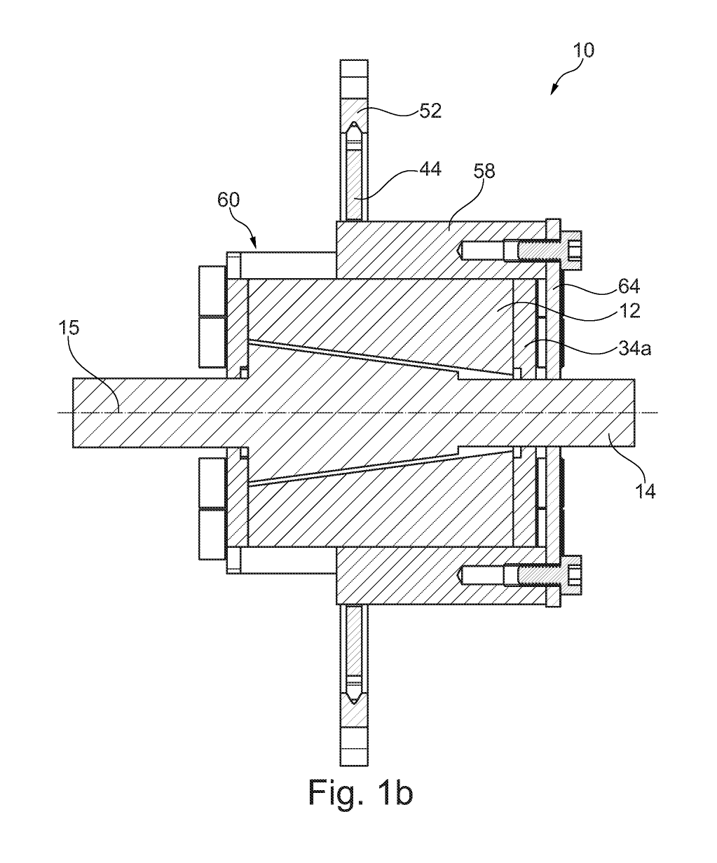

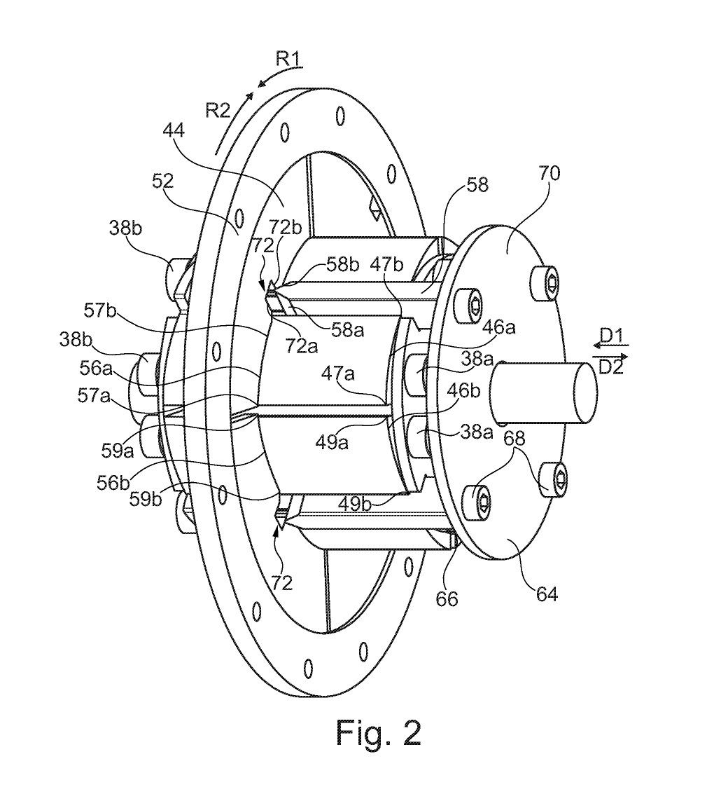

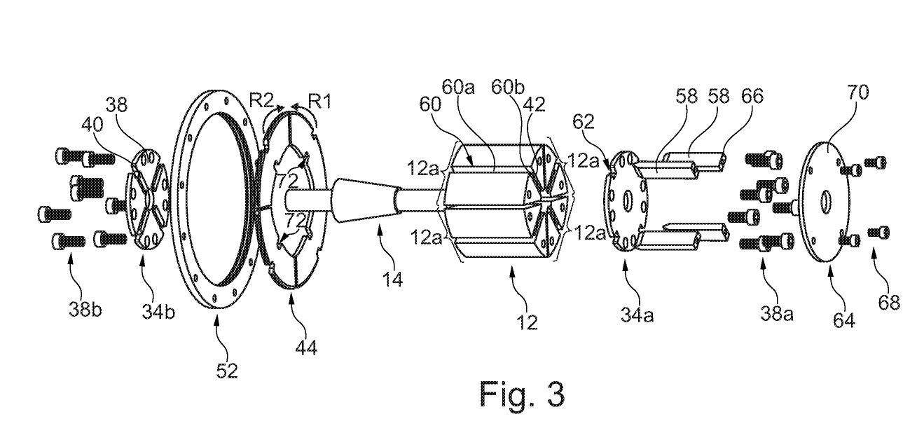

FIG. 1a shows a cross-sectional side view of a bi-directional wedge clutch 10 in accordance with an embodiment of the present invention in a locked orientation of the clutch; FIG. 1b shows a cross-sectional side view of bi-directional wedge clutch 10 in a released orientation of the clutch; FIG. 2 shows a perspective view of bi-directional wedge clutch 10; and FIG. 3 shows an exploded view of bi-directional wedge 10. Wedge clutch 10 is described below with respect to FIGS. 1a, 1b, 2 and 3.

Wedge clutch 10 includes a collapsing inner race 12 configured for mating with a conned driver 14. Both inner race 12 and driver 14 are rotatable about a center axis 15 of clutch 10. As used herein, the terms axially, radially and circumferentially refer to center axis 15. More specifically, an inner circumferential surface 16 of inner race 12 is configured for frictionally mating by with an outer circumferential surface 18 of conned driver 14 due to a tapered fit, with both mating surfaces 16, 18 being frustoconical in shape. Inner frustoconical circumferential surface 16 of inner race 12 is axially longer than outer frustoconical circumferential surface 18, such that driver 14 is axially movable with respect to inner race 12 to cause surfaces 16, 18 to release from each other, and tapers outwardly from a radially smaller end 20 of inner race 12 to a radially larger end 22 of inner race 12. Inner circumferential surface 18 of conned driver 14, which is formed on a frustoconcial portion 24 of driver 14, also tapers outwardly from a radially smaller end 26 of driver 14 to a radially larger end 28 of driver 14. At radially smaller end 26, driver 14 is provided with a first shaft portion 30 protruding from frustoconical portion 24 and, at radially larger end 28, driver 14 is provided with a second shaft portion 32 protruding from frustoconical portion 24. In a locked orientation of clutch 10, driver 14 is shifted axially and held at radially smaller end 20 of inner race 12. In a release event of clutch 10, driver 14 is shifted axially momentarily to radially larger end 22 of inner race 12.

End caps 34a, 34b are fixed to axial ends 36a, 36b of inner race 12, with frustoconical portion 24 of driver 14 being received axially between end caps 34a, 34b. More specifically, end cap 34a is fixed to radially thicker axial end 36a of inner race 12 by a plurality of threaded fasteners 38a that pass through threaded holes in end cap 34a and into threaded holes in inner race 12. Similarly, end cap 34b is fixed to a radially thinner axial end 36b of inner race 12 by a plurality of threaded fasteners 38b that pass through threaded holes in end cap 34b and into threaded holes in inner race 12. End caps 34a, 34b retain pieces 12a of the inner race 12 to allow torque to be carried axially and but allow freedom to be maintained radially. More specifically, end caps 34a, 34b are provided with keys or teeth thereon that fit into slots on inner race 12 such that end caps 34a, 34b and inner race 12 are configured to turn as an assembly but inner race pieces are allowed to move towards center axis 15 as inner race 12 collapses One or both of end caps 34a, 34b may also each include a respective feature allowing torque transmission, which in this embodiment are the keys or teeth.

Inner race 12 is formed by a plurality of pieces 12a. As shown particularly in FIG. 3, in this embodiment, inner race 12 includes four separate pieces 12a, with each piece 12a forming approximately a circumferential quarter of inner race 12 and extending axially between axial ends 36a, 36b to contact both plates 34a, 34b. At a radially extending surface 38 thereof, each end plate 34a, 34b is provided with four radially extending axial protrusions 40 for aligning ends plates 34a, 34b with the respective axial ends 36a, 36b of inner race 12. Each protrusion 40 is received in a corresponding radially extending axial depression 42 in the respective axial end 36a, 36b of inner race 12, with each segment 12a being provided with a depression 42 at each axial end 36a, 36b.

A wedge plate 44 is provided at an outer circumferential surface 46 of inner race 12. An outer circumferential surface 48 of wedge plate 44 mates with an inner circumferential surface 50 of an outer race 52. Wedge plate 44 may be formed by a plurality of wedge plates sandwiched together axially, with all of the wedge plates being held at their inner circumferences by inner race 12 and at their outer circumferences by outer race 52. An outer circumferential surface 54 of outer race 52 may be configured for mating with a driven member to drive the driven member, for example by being provided with gears.

As shown particularly in FIGS. 2 and 3, wedge plate 44, at an inner circumferential surface 56 thereof, has ramps 56a, 56b extending in both circumferential directions that mate with ramps 46a, 46b on an outer circumferential surface 46 of inner race 12 to allow torque transmission. In this embodiment, each piece 12a is provided with one ramp 46a and one ramp 46b. Each ramp 46a tapers radially outward in a circumferential or rotational direction R1 such that outer circumference 46 is radially larger at an outer end 47a of ramp 46a than at an inner end 47b of ramp 46a. Each ramp 46b tapers radially outward in a circumferential or rotation direction R2 such that outer circumference 46 is radially larger at an outer end 49a of ramp 46b than at an inner end 49b of ramp 46b. Each ramp 56a is radially aligned with and tapered with a contour that matches one ramp 46a and each ramp 56b is radially aligned with and tapered with a contour that matches one ramp 46b. Accordingly, each ramp 56a tapers radially outward in a circumferential or rotational direction R1 such that inner circumference 56 is radially larger at an outer end 57a of ramp 56a than at an inner end 57b of ramp 56a. Each ramp 56b tapers radially outward in a circumferential or rotation direction R2 such that outer circumference 56 is radially larger at an outer end 59a of ramp 56b than at an inner end 59b of ramp 56b.

If inner race 12 is rotated in direction R1, ramps 56b slide circumferentially along ramps 46b and climb ramps 46b such that wedge plate 44 is forced radially outward into outer race such that outer circumference 48 of wedge plate 44 engage inner circumference 50 of outer race 52 and wedge plate 44 drive outer race 52 in direction R1. If inner race 12 is rotated in direction R2, ramps 56a slide circumferentially along ramps 46a and climb ramps 46a such that wedge plate 44 is forced radially outward into outer race such that outer circumference 48 of wedge plate 44 engage inner circumference 50 of outer race 52 and wedge plate 44 drive outer race 52 in direction R2.

Clutch 10 further includes releases in the form wedge blocks 58 each located in a respective one of axially extending channels 60 formed in inner race 12 by walls 60a extending radially inward from outer circumferential surface 46 of inner race 12 to a bottom axially extending wall 60b. In this embodiment, there are four wedge blocks 58 and each piece 12a includes one channel 60. End plates 34a also includes notches 62 (FIG. 3) aligned with channels 60 each for receiving one respective wedge block 58. Wedge blocks 58 are retained by a wedge block plate 64 connected to an axial end 66 of each wedge block 58. More specifically, wedge block plate 64 is fixed to each wedge block 58 by a respective one of a plurality of threaded fasteners 68 that pass through threaded holes in wedge block plate 64 and into threaded holes in wedge blocks 58. Wedge block plate 64 is axially offset from end plate 34a and an outer radially extending surface 70 of wedge block plate 64 may be contacted to actuate wedge blocks 58 axially.

Wedge blocks 58 are axially slidable in channels 60 into respective radially extending grooves 72 formed inner circumferential surface 56 of wedge plate 44 to engage wedge plate 44 to release clutch 10 and maintain a released orientation of clutch 10. More specifically, as shown in FIG. 2, each wedge block 58 includes two angled faces 58a, 58b configured for contacting a respective corresponding side wall 72a, 72b of groove 72 to allow wedge blocks 58 to slide into groove 72 to prevent the wedging of ramps 46a, 46b with the respective ramps 56a, 56b. For example, if inner race 12 and wedge plate 44 are engaged and rotating in direction R1 and thus ramps 56b have slide circumferentially along ramps 56b to force wedge plate 44 into outer race 52, sliding wedge block plate 64 and wedge blocks 58 in an axial direction D1 causes face 58b of wedge block 58 to contact wall 72b, forcing wedge plate 44 to slide circumferentially in direction R2 with respect to inner race 12, ending the wedging of ramps 46b, 56b and causing wedge plate 44 to disengage from outer race 52 to release clutch 10. In contrast, if inner race 12 and wedge plate 44 are engaged and rotating in direction R2 and thus ramps 56a have slide circumferentially along ramps 56a to force wedge plate 44 into outer race 52, sliding wedge block plate 64 and wedge blocks 58 in an axial direction D1 causes face 58a of wedge block 58 to contact wall 72a, forcing wedge plate 44 to slide circumferentially in direction R1 with respect to inner race 12, ending the wedging of ramps 46a, 56a and causing wedge plate 44 to disengage from outer race 52 to release clutch 10. To end the release and to again force clutch 10 into a locked orientation, wedge block plate 64 and wedge blocks 58 are slide in an axial direction D2 opposite of direction D1 to remove wedge blocks 58 from grooves 72 such that ramps 56a reengage and climb ramps 46a or ramps 56b reengage and climb ramps 46b, depending on the direction of rotation R1 or R2.

In summary, in the locked orientation of clutch 10, which is shown in FIGS. 1a and 2, torque is transmitted into one or both of end caps 34a, 34b for example by The could be accomplished by endcaps 34a, 34b being built into a shaft or being directly or indirectly attached to a gear. The torque is then transmitted to inner race 12 through a mechanical connection between end caps 34a, 34b and inner race 12. Rotation of inner race 12 causes wedge plate 44 to climbs the ramps on the outer circumferential surface 46 of inner race 12, forcing wedge plate 44 radially outward toward outer race 52, causing wedge plate 44 to be wedged radially between inner circumferential surface 50 of outer race 52 and outer circumferential surface 46 of inner race 12 so torque is transmitted from inner race 12 via wedge plate 44 to outer race 52. To release clutch 10 into a released orientation, which is shown in FIG. 1b, wedge block plate 64 is actuated towards wedge plate 44, causing wedge blocks 58 to contact wedge plate 44 while conned driver 14, which is movable independently of wedge blocks 58, is momentarily forced to radially larger end 22 of inner race 12, causing the pieces of inner race 12 to collapse radially inward toward center axis 15. This inward collapsing movement of pieces of inner race 12 toward center axis 15 gives wedge plates 38 the freedom to allow wedge blocks 58 to enter into grooves 72 in wedge plate 44 and keep wedge plate 44 from climbing the ramps 46a, 46b on outer circumferential surface 40 of inner race 12.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A bi-directional wedge clutch for a motor vehicle drive train comprising:
a driver;
an inner race configured for being driven by the driver;
a wedge plate on an outer circumferential surface of the inner race;
an outer race on an outer circumferential surface of the wedge plate, the inner race and the wedge plate being configured such that torque is transferrable in two rotational directions from the inner race to the outer race via the wedge plate; and
a releaser configured for sliding axial in a channel formed in the outer circumferential surface of the inner race and engaging the wedge plate to release the clutch when the inner race is rotating in either of the two rotational directions.

2. The bi-directional wedge clutch as recited in claim 1 wherein the inner race includes first inner race ramps configured for mating with first wedge plate ramps to wedge the wedge plate against the outer race when the inner race is rotated in a first of the two rotational direction, the inner race including second inner race ramps configured for mating with second wedge plate ramps to wedge the wedge plate against the outer race when the inner race is rotated in a second of the two rotational direction.

3. The bi-directional wedge clutch as recited in claim 1 wherein the releaser includes a wedge block, the wedge block being configured for contacting walls of a groove formed in inner circumferential surface of the wedge plate to release the clutch when the inner race is rotating in either of the two rotational directions.

4. The bi-directional wedge clutch as recited in claim 3 wherein the wedge block includes a first angled face configured for contacting a first of the walls of the groove to release the clutch when the inner race is rotating in a first of the two rotational directions, the wedge block including a second angled face configured for contacting a second of the walls of the groove to release the clutch when the inner race is rotating in a second of the two rotational directions.

5. The bi-directional wedge clutch as recited in claim 1 wherein inner race includes a plurality of pieces each extending axially from a first end cap to a second end cap, the channel being a plurality of channels, each of the pieces of the inner race including one of the channels, the releaser including a plurality of wedge blocks, each of the wedge blocks being axially slidable in one of the channels to release the clutch.

6. The bi-directional wedge clutch as recited in claim 1 further comprising a wedge block plate fixed to an axial end of each of the wedge blocks.

7. A method of forming a bi-directional wedge clutch for a motor vehicle drive train comprising:
providing an inner race onto an outer circumferential surface of a driver;
providing a wedge plate on an outer circumferential surface of the inner race;
providing an outer race on an outer circumferential surface of the wedge plate such that the inner race and the wedge plate are configured such to transfer torque in two rotational directions from the inner race to the outer race via the wedge plate; and
providing a releaser configured for sliding axial in a channel formed in the outer circumferential surface of the inner race and engaging the wedge plate to release the clutch when the inner race is rotating in either of the two rotational directions.

8. The method as recited in claim 7 wherein the inner race includes first inner race ramps configured for mating with first wedge plate ramps to wedge the wedge plate against the outer race when the inner race is rotated in a first of the two rotational direction, the inner race including second inner race ramps configured for mating with second wedge plate ramps to wedge the wedge plate against the outer race when the inner race is rotated in a second of the two rotational direction.

9. The method as recited in claim 7 wherein the releaser includes a wedge block, the wedge block being configured for contacting walls of a groove formed in inner circumferential surface of the wedge plate to release the clutch when the inner race is rotating in either of the two rotational directions.

10. The method as recited in claim 9 wherein the wedge block includes a first angled face configured for contacting a first of the walls of the groove to release the clutch when the inner race is rotating in a first of the two rotational directions, the wedge block including a second angled face configured for contacting a second of the walls of the groove to release the clutch when the inner race is rotating in a second of the two rotational directions.
